(19) United States
(12) Patent Application Publication
(10) Pub. No.: US 2007/0217857 A1
(43) Pub. Date: Sep. 20, 2007

(54) Holder cup for supporting a stick of cosmetic product

(76) Inventor: Hsiao Tzu Ho, Shanghai (CN)

Correspondence Address: ST. ONGE STEWARD JOHNSTON & REENS, LLC, 986 BEDFORD STREET, STAMFORD, CT, 06905-5619, US

(21) Appl. No.: 11/453,420

(22) Filed: Jun. 15, 2006

(30) Foreign Application Priority Data
Mar. 15, 2006 (EP) 06005279.2

(51) Int. Cl. A45D 40/20; B43K 21/08

(52) U.S. Cl. 401/88; 401/78

(57) ABSTRACT

A holder cup for supporting a stick of cosmetic product, intended to be slideably mounted in a sleeve, the said sleeve being held in a jacket, the said holder comprising a base and a cylindrical lateral skirt, the internal face of the said lateral skirt comprising attachment means in the form of axial ribs, the external face being provided with guidance stubs cooperating with a set of helical grooves formed on the said jacket. The stubs are elastically connected to the said lateral skirt, and the top edge of the said cup extends around the stick continuously.

### CROSS-REFERENCE TO RELATED APPLICATIONS

This application claims priority of EP patent application No. 06005279.2 filed on Mar. 15, 2006.

### FIELD OF THE INVENTION

The invention concerns a holder cup for supporting a stick of cosmetic product, an assembly for packaging and dispensing the stick of cosmetic product comprising a stick supported by a holder cup, and the use of the said cup in order to produce an assembly for packaging and dispensing a stick of cosmetic product.

### BACKGROUND OF THE INVENTION

There is known, in particular from the teaching of FR 2 548 889, a packaging and dispensing device provided with a stick cup intended to support a lipstick. The cup is introduced into a sleeve held axially in a jacket. This cup is provided with two stubs which, passing through two axial slots in the sleeve, are intended to cooperate with helical grooves in the jacket, in order to allow axial movement of the cup in the sleeve.

The top edge of the cup is divided by axial slots which axially delimit deformable lugs carrying the stubs. These lugs project radially towards the outside of the skirt.

The top edges of the lugs come into abutment against the sleeve and constitute friction points when the cup is sliding in the sleeve. This arrangement is responsible for small lateral offsets on the base of the cup liable to give rise to a locking of the sliding and an impairment of the lipstick.

In addition, because of their contact with the sleeve, these lugs, when the cup slides, undergo vibrations relating to the imperfections on the internal wall of the sleeve. These vibrations are responsible for a deformation of the portion of the stick in contact with the lugs, which gives rise to a risk of disconnection of the stick.

Moreover, during the mounting of the stick or when the cup is introduced into the sleeve, the lugs are greatly stressed, which may lead to a tearing of the wall at the bottom ends of the slots.

In addition, when a radial compression is exerted on the top edge of the cup on mounting and in particular when it is introduced into the sleeve, the slots sometimes close up in an uncontrolled manner, causing overlaps of the facing edges. These overlaps, due to the fragility of this structure, promote subsequent risks of distortion and jamming of the cup.

### SUMMARY OF THE INVENTION

The invention aims to remedy these problems by proposing a cup of the above type characterised in that the said stubs are elastically connected to the said lateral skirt, the top edge of the said cup extending around the stick continuously.

According to an advantageous characteristic of the invention, each stub is carried by a tongue housed in a window provided through the lateral skirt.

According to another characteristic, the elastic connection of the lugs is formed by the area of attachment of the tongue to the skirt.

According to a specific variant, the said tongues are diametrically opposed on the skirt.

The said lugs are preferably situated substantially at the centre of the said tongue.

According to yet another characteristic, the said axial ribs have a triangular section, the apex of which is oriented radially towards the centre of the said cup.

In addition, the top end of each rib is bevelled so as to facilitate the introduction of the said cosmetic stick in the said cup.

According to an advantageous variant, the internal face of each of the said tongues is fixed to the top end of one of the said axial ribs so that a radial compression exerted on the said stubs gives rise to an elastic deformation of the tongue allowing anchoring of the rib in the said stick of cosmetic product.

According to yet another variant, the top edge of the said lateral skirt is thinned.

Preferably, the bottom edge of the said lateral skirt is extended downwards beyond the base and is bevelled so as to facilitate the mounting of the said cup in the said sleeve.

According to a particular variant, the window has a contour in the form of an inverted U and provides with the tongue an intermediate space whilst the tongue has a profile complementary to that of the said window.

Another object of the invention is an assembly for packaging and dispensing a stick of cosmetic product comprising a cup supporting the said stick having at least one of the characteristics defined above.

Yet another object of the invention is a use of the said cup for producing an assembly for packaging and dispensing a stick of cosmetic product comprising in particular a jacket provided with a set of helical grooves and an internal sleeve receiving the said cup slideably.

The cup of the invention has good rigidity at the top part suitable for holding the stick in an axial position both during its use and during the sliding of the cup.

Moreover, the damping capacity of the flexible tongues procures for the stubs of the cup flexibility in guidance which prevents the phenomena of jamming or locking of the sliding mechanism.

The position of these tongues, substantially halfway up, also allows static and dynamic axial fastening of the cup.

### BRIEF DESCRIPTION OF THE DRAWINGS

Other objects and advantages of the invention will emerge during the following description, given with reference to the accompanying drawings, in which:

FIG. 1 depicts an exploded view of an assembly for packaging and dispensing a stick of cosmetic product comprising a cup according to the invention,

FIG. 2 depicts a profile view of an embodiment of the cup of the invention,

FIG. 3 depicts a plan view of the embodiment in FIG. 2, and

FIG. 4 depicts a view in axial section of the embodiment in the previous figures.

### DETAILED DESCRIPTION OF THE DRAWINGS

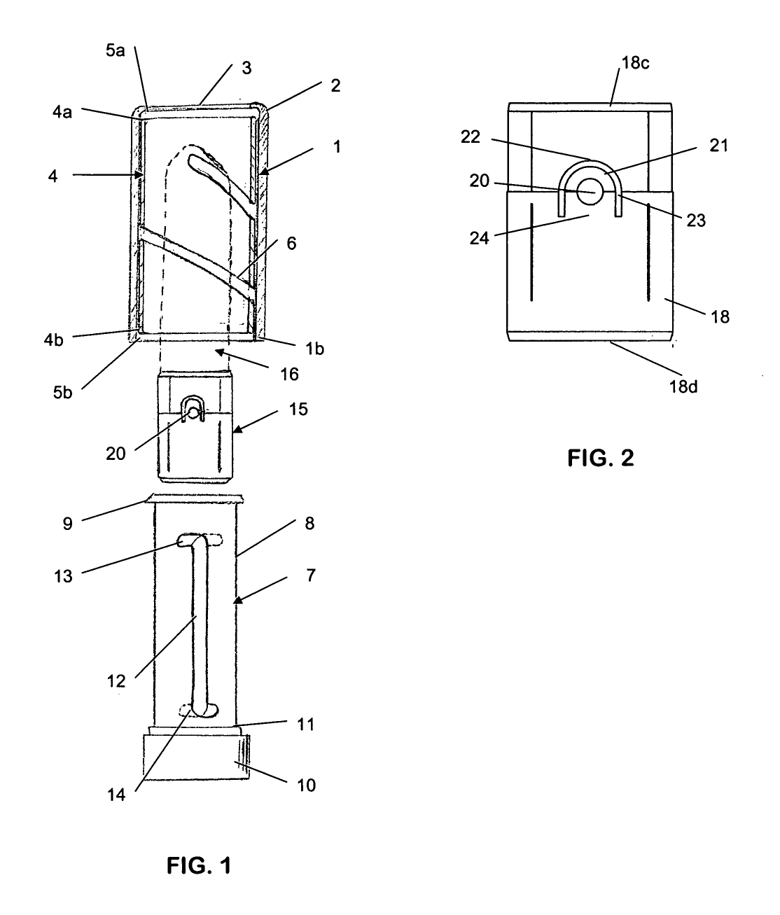

The cup according to the invention is intended to be incorporated in an assembly for packaging and dispensing a stick of cosmetic product as depicted in FIG. 1, for example of the lipstick case type.

This assembly comprises a cylindrically shaped envelope 1 providing the external protection, which is produced, for example, from plastics material or metal. The envelope 1 is provided at its top edge with a rounded collar 2 delimiting a central orifice 3.

The envelope 1 is lined internally with a thin cylindrical jacket 4 generally made from plastic. The top edge 4a of the jacket 4 delimits an annular space 5a with the collar 2 of the envelope 1. At its bottom edge 4b, the jacket 4 delimits an annular step 5b with the bottom edge 1b of the envelope 1.

Two identical and diametrically opposed helical grooves 6 are provided on the internal wall of the jacket 4.

A cylindrically shaped sleeve 7 is mounted so as to rotate freely about the central longitudinal axis of the jacket 4. The sleeve 7 has a cylindrical part 8 with a diameter slightly less than the inside diameter of the jacket 4, a top end provided with an annular bulge 9 and a bottom end provided with a maneuvering end piece 10.

Two identical and diametrically opposed slots 12 are formed through the wall of the sleeve 7 over a major part of the height of the central cylindrical part 8 and terminates at each end at notches 12, 14. For one and the same axial slot 12, the notches 13 and 14 are provided on each side of its longitudinal axis.

The central cylindrical part 8 is connected to the maneuvering end piece 10 by a radial shoulder 11 intended to be inserted in the annular step 5b. The jacket 4 is held axially between the radial shoulder 11 at its bottom edge 4b and the annular bulge 9 at its top edge 4a.

The sleeve 7 is held axially at its top part by the holding of the annular bulge 9 in the annular space 5a and can be driven in rotation inside the jacket 4 by maneuvering the end piece 10.

The cup 15 of the invention is cylindrically shaped overall and is mounted slideably in the sleeve 7. The cup 15 is intended to receive the bottom part of a stick 16 of cosmetic product made from a paste of the lipstick type.

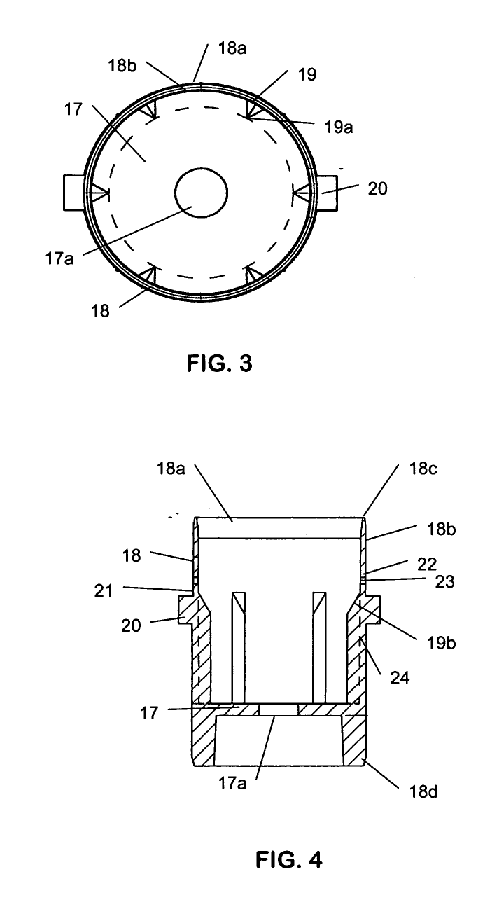

This cup 15 (FIGS. 2 and 3) is produced in a single piece, roughly of revolution in shape, which comprises a base 17 provided with a central orifice 17a and surmounted by a cylindrical lateral skirt 18.

The internal face 18a of the lateral skirt 18 comprises means of attaching the stick 16 in the form of axial ribs 19.

The external face of the skirt 18b is provided with guidance stubs 20 housed on the one hand in the axial slots 12 formed through the wall of the sleeve 7 and the end of which cooperates on the other hand with a set of helical grooves 6 carried by the internal wall of the said jacket 4.

According to the invention, the stubs 20 are connected elastically to the lateral skirt 18 whilst the top edge 18c of the said skirt 18 extends around the stick 16 continuously, gripping it on its periphery.

Each stub 20 is carried by a tongue 21 which comes to be placed in a window 22 formed through the lateral skirt 18 of the stick 15.

The elastic connection of the lugs 20 consists here of the area 24 of bottom attachment of the tongue 21 to the skirt 18, forming a hinge.

The tongue 21, which has a curvature corresponding to the radius of the cylindrical cup 15, thus has a capacity for transverse movement on each side of the plane of the window 22.

In the embodiment depicted, the two tongues 21 are diametrically opposed and the stubs 20 are situated substantially at the centre of each tongue 21.

The windows 22 have a contour in the shape of an inverted U and, with the respective tongues 21, form an intermediate space 23.

The tongues 21 preferably have a profile complementary to that of the windows 22.

The axial ribs 19 have a triangular cross section, the apex 19a of which (FIG. 4) is oriented radially towards the centre of the said cup 15 so as to penetrate partially the material of the stick 16 in order to reinforce the anchoring and holding of the stick.

The top end 19b of each rib 19 is bevelled and the top edge 18c of the lateral skirt 18 is thinned in order to facilitate the introduction of the stick 16 in the said cup 15.

The internal face of each of the tongues 21 secured to the top end of one of the axial ribs 19 so that a radial compression on the said stubs 20 causes an elastic flexion of the tongue 21 towards the inside of the cup 15 and the reinforcement of the anchoring of the rib 19 in the stick 16 of cosmetic product.

The bottom edge 18d of the lateral skirt 18 is extended downwards beyond the base 17 and is bevelled in order to facilitate the mounting of the said cup 1 in the sleeve 7.

What is claimed is:

1. A holder cup for supporting a stick of cosmetic product, intended to be mounted slideably in a sleeve, said sleeve being held in a jacket, said cup comprising a base and a cylindrical lateral skirt, the internal face of said lateral skirt comprising attachment means in the form of axial ribs, the external face being provided with guidance stubs cooperating with a set of helical grooves formed on said jacket, characterised in that said stubs are elastically connected to said lateral skirt, the top edge of said cup extending around the stick continuously.

2. A cup according to claim 1, characterised in that each stub is carried by a tongue housed in a window formed through the lateral skirt.

3. A cup according to claim 2, characterised in that the elastic connection of the stubs is formed by the area of attachment of the tongue to the skirt.

4. A cup according to claim 2, characterised in that said tongues are diametrically opposed.

5. A cup according to claim 2, characterised in that said stubs are situated substantially at the centre of said tongue.

6. A cup according to claim 1, characterised in that said axial ribs have a triangular cross section, a vertex of which is oriented radially towards the centre of said cup.

7. A cup according to claim 1, characterised in that a top end of each rib is bevelled so as to facilitate the introduction of said cosmetic stick (16) in said cup.

8. A cup according to claim 2, characterised in that the internal face of each of said tongues is fixed to a top end of one of said axial ribs so that a radial compression exerted on said stubs causes an elastic deformation of the tongue allowing an anchoring of the rib in said stick of cosmetic product.

9. A cup according to claim 1, characterised in that the top edge of said lateral skirt is thinned.

10. A cup according to claim 1, characterised in that a bottom edge of said lateral skirt is extended downwards beyond the base and is bevelled in order to facilitate the mounting of said cup in said sleeve.

11. A cup according to claim 2, characterised in that the window has a contour in the shape of an inverted U and forms with the tongue an intermediate shape.

12. A cup according to claim 2, characterised in that the tongue has a profile complementary to that of said window.

13. An assembly for packaging and dispensing a stick of cosmetic product comprising a cup supporting said stick according to claim 1.

14. Use of said cup according to claim 1 for producing an assembly for packaging and dispensing a stick of cosmetic product, comprising a jacket provided with a set of helical grooves and an internal sleeve receiving said cup slideably.
